(19) United States
(12) Patent Application Publication
(10) Pub. No.: US 2023/0010180 A1
(43) Pub. Date: Jan. 12, 2023

(54) PARAFINITARY NEURAL LEARNING

(71) Applicant: University of Georgia Research Foundation, Inc., Athens, GA (US)

(72) Inventor: Dylan Scott Pozorski, Watertown, WI (US)

(21) Appl. No.: 17/850,691

(22) Filed: Jun. 27, 2022

Related U.S. Application Data
(60) Provisional application No. 63/219,099, filed on Jul. 7, 2021.

(51) Int. Cl. G06N 3/04

(52) U.S. Cl. CPC G06N 3/04

(57) ABSTRACT

Disclosed are various embodiments for a parafinitary neural network. A first node in the neural network can receive an input. The first node can determine that the input is outside the input domain for the node of the neural network. The first node can then create a second node of the node of the neural network, the second node having the same edges and edge weights as the first node. Next, the first node can scale down each incoming edge of the first node and scale down each incoming edge of the second node. Finally, the first node can scale up each outgoing edge of the second node.

### CROSS-REFERENCE TO RELATED APPLICATION

This application claims priority to, and the benefit of, copending U.S. Provisional Patent Application No. 63/219,099, entitled Parafinitary Learning and filed on Jul. 7, 2021, which is incorporated by reference as if set forth herein in its entirety.

### BACKGROUND

Individual nodes (sometimes referred to as neurons or perceptrons) of neural networks are often provided with an input for analysis. Depending on the weight of the input, the node can decide whether or not to propagate an output to another node in the neural network. Moreover, the node can decide the magnitude of the output, which can reflect the strength of the signal. However, in some instances, the magnitude of the input to a node can exceed the scope of its input domain—the signal could be too big or too small for the node to accurately or adequately evaluate and propagate an output. This can lead to inaccurate or unstable results.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1-3 are drawings depicting the implementation of an embodiment of the present disclosure within a neural network.

FIG. 4 is a schematic block diagram according to various embodiments of the present disclosure.

FIG. 5 is a flowchart illustrating one example of functionality implemented as portions of an application executed in a computing environment in the network environment of FIG. 4 according to various embodiments of the present disclosure.

### DETAILED DESCRIPTION

Disclosed are various approaches for implementing a neural network that dynamically adds nodes in response to inputs that are outside the input domain of individual nodes. A first node in the neural network can receive an input. The first node can determine that the input is outside the input domain for the node of the neural network. The first node can then create a second node of the node of the neural network, the second node having the same edges and edge weights as the first node. Next, the first node can scale down each incoming edge of the first node and scale down each incoming edge of the second node. Finally, the first node can scale up each outgoing edge of the second node.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

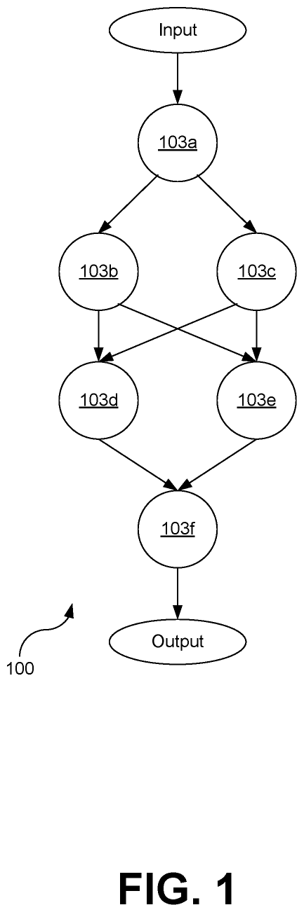

FIG. 1 depicts an example of a neural network 100. The neural network 100 comprises a plurality of nodes 103 (e.g., nodes 103a, 103b, 103c, 103d, 103e, and 103f). Each node 103 in a layer can be connected to one or more nodes 103 in a subsequent layer. Although the neural network 100 depicted in FIG. 1 is a fully connected neural network, neural networks 100 that are not fully connected can also be used in various embodiments of the present disclosure. When an input is provided to the first node 103a of the neural network 100, the first node 103a processes the input and provides a result to nodes 103b and/or 103c. Nodes 103b and 103c can each process the output of node 103a and provide a result to nodes 103d and 103e. Nodes 103d and 103e can process their inputs from nodes 103b and 103c and provide outputs to node 103f, which can generate a final output.

In some instances, however, the input domain for a node 103 may be less than the input itself. As a simplistic example, if the input domain for a node 103 were a vector of weights ranging between −2 and +5, an input vector with weights less than −2 or greater than +5 would contain values that are outside of the input domain for the node 103. If the node 103 were to process such an input vector, it might inaccurately update its weights or provide an inaccurate output to a subsequent node 103.

To address these situations, individual nodes 103 of the neural network 100 can be configured to add an additional node 103 to the same layer of the neural network 100. The additional node 103 can have the same incoming and outgoing edges as the original node 103. The incoming edge weights for the original node 103 and the additional node 103 can be scaled down to fit within the input domain of each node 103. Meanwhile, the outgoing edge weights for the additional node 103 can be scaled up. As a result, the combination of the original node and the additional node can appropriately and accurately process the input even though the input originally exceeded the input domain for the node 103.

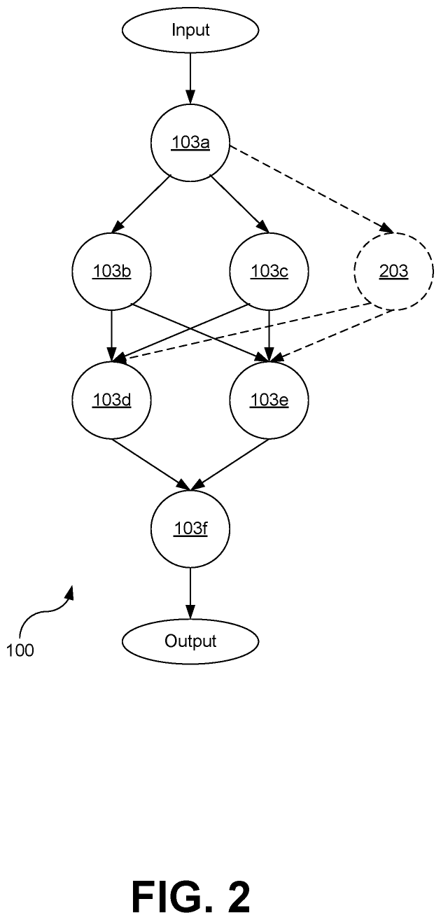

FIG. 2 depicts an example of the neural network 100 when the node 103c divides. As a result, an additional node 203 is added to the neural network 100 in the same layer as the node 103c. Moreover, all of the edges of the node 103c are duplicated for the additional node 203. As previously described, the weights of the edges for nodes 103c and 203 can be scaled as a result of the division. This allows for an input to node 103c that is larger than the input domain of node 103c to be processed by the combination of nodes 103c and 203.

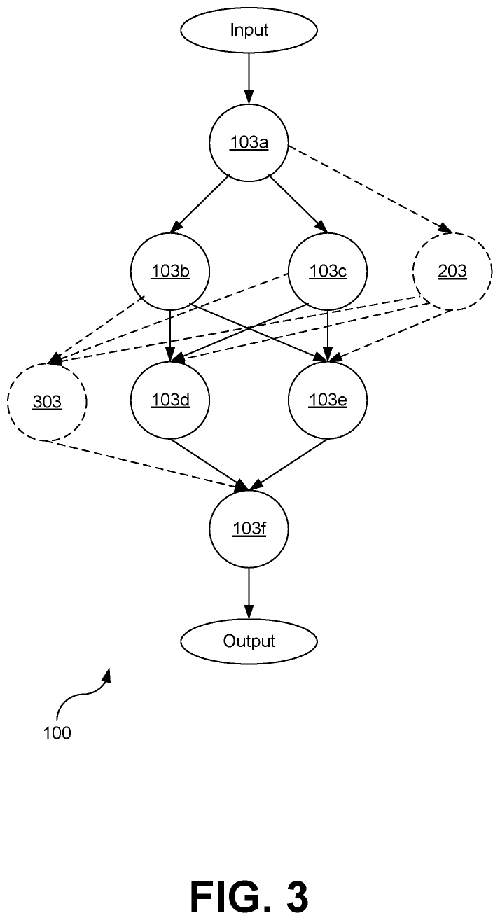

As data moves from one layer to the next layer of the neural network 100, other nodes 103 may also divide themselves in order to process data appropriately. To illustrate this point, FIG. 3 depicts the neural network 100, wherein node 103d has divided in order to add another node 303 to the neural network 100. The additional node 303 is added to the same layer of the neural network 100 as node 103d. Moreover, as previously described, all of the edges of the node 103d are duplicated for the additional node 303. The weights of the edges of the nodes 103d and 303 can also be scaled as the result of the division. This allows for an input to node 103d that is larger than the input domain of the node 103d to be processed by the combination of nodes 103d and 303.

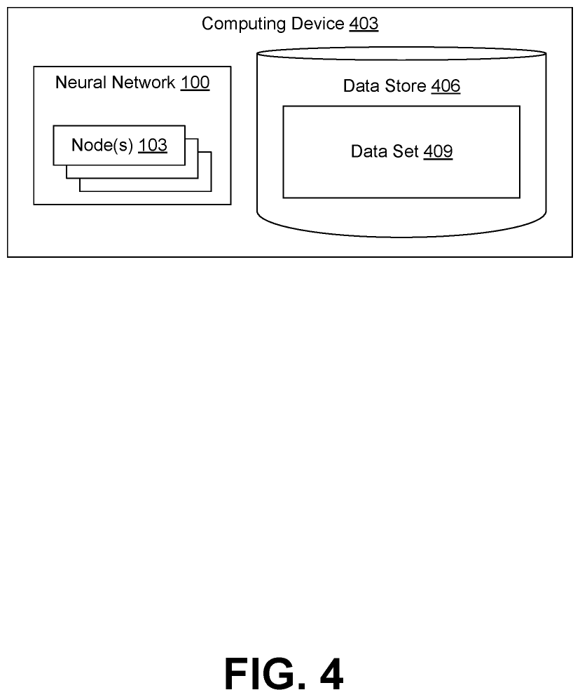

With reference to FIG. 4, shown is a schematic block diagram of a computing device 403 that could be used to implement the various embodiments of the present disclosure. The computing device can include one or more processors as well as working memory (e.g., random access memory) and long term memory (e.g., hard disk drives, optical drives, solid state drives, etc.). Various applications can be stored in the long-term memory that, when loaded into the working memory and executed by the processor(s), can cause the computing device 403 to perform various functions.

For example, the neural network 100 could be stored in the long-term memory that, when loaded into the working memory and executed by the processor(s), causes the computing device 403 to perform various machine learning options. The neural network 100 can be executed to solve various artificial intelligence or machine-learning problems. This could include, for example, analyzing and classifying data; including pattern and sequence recognition, data processing, including filtering, clustering, blind signal separation, and compression; and function approximation, including time series prediction and modeling.

Also, various data can be stored in a data store 406 that is implemented by the computing device 403. The data store 403 can be representative of a plurality of data stores 403, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data set 409 to be evaluated or analyzed by the neural network 100 can be stored or maintained in the data store 406.

The data set 409 can represent the set of data that the neural network 100 is to analyze. The data set 409 could be fed or provided to an input layer or input node 103 of the neural network 100, which then creates and propagates signals to subsequent nodes 103 in the neural network 100. In some instances, the data set 409 could be formatted in order to facilitate analysis by the nodes 103 of the neural network 100 (e.g., as matrices or vectors containing multiple values).

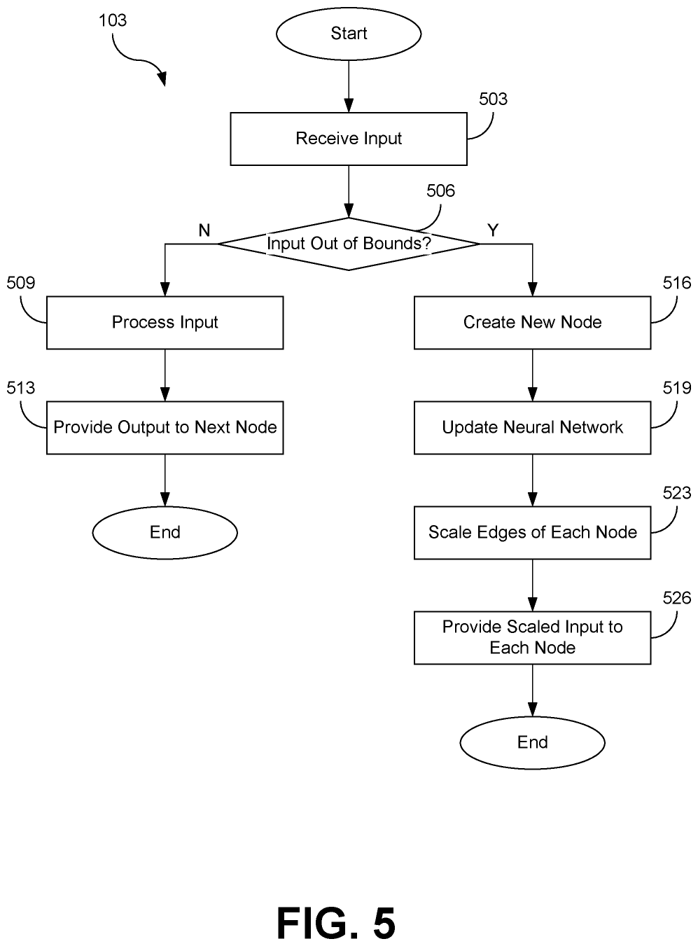

Referring next to FIG. 5, shown is a flowchart that provides one example of the operation of a portion of the individual nodes 103 of the neural network 100. The flowchart of FIG. 5 provides merely an example of the many different types of functional arrangements that can be employed to implement the operation of the depicted portion of the node 103 of the neural network 100. As an alternative, the flowchart of FIG. 5 can be viewed as depicting an example of elements of a method implemented within the computing device 403

Beginning with block 503, a node 103 in the neural network 100 can receive an input, such as a vector or matrix containing one or more values. The input could be loaded directly from the data set 409 of the data store 406 (e.g., if the node 103 were in the first layer of the neural network 100), or the input could be an output received from one or more nodes 103 of a preceding layer of the neural network 100.

Then, at block 506, can determine whether the input received at block 503 contains any values that are outside the bounds of the input domain of the node 103. For example, if the node 103 is configured to process input values ranging between −5 and +5, but one or more values in the input were greater than +5 or less than −5, then the input could be considered to be outside the input domain of the activation function of the node 103.

If the process proceeds to block 509, the node 103 can process the input as programmed. This can include generating a resulting output for the input according to the activation function programmed for the node 103.

Then, at block 513, the node 103 can provide the output to the next node 103. The next node 103 could include a node 103 in a subsequent layer connected to the node 103 (e.g., node 103d receives the output of node 103b as illustrated in FIGS. 1-3). In other instances, there might not be a subsequent layer to the neural network 100. In these instances, the output of the node 103 could be provided as the result of the neural network 100.

However, if the process instead proceeded to block 516, the node 103 can create a new node 103, such as example nodes 203 or 303 as illustrated in FIGS. 2 and 3. To create the new node 103, the node 103 can copy or clone itself. Accordingly, the new node 103 could have the same activation function(s) and same input domain as the original node 103.

Subsequently, at block 519, the node 103 can update the neural network 100 to incorporate the new node 103 by connecting the new node 103 to other nodes 103 in the neural network 100. For example, the node 103 could create duplicate edges from nodes in the previous layer of the neural network for the new node 103. In other words, each node 103 of the previous layer of the neural network 100 that is connected to the original node 103 would be connected to the new node 103. Likewise, each node 103 in a subsequent layer that is connected to the original node 103 would also be connected to the new node 103. These duplicated edges for the new node 103 should initially be of equal weight to the edges of the original node 103.

Proceeding to block 523, the node 103 can cause the edges of itself and the new node 103 to be scaled to appropriately process the input received at block 503. First, the node 103 can scale the input edges for itself and for the new node 103. The input edges for the original node 103 and the new node 103 can be scaled using the following approach. Assuming that ϕ is a value equal to the Golden Ratio (algebraically equal to

$$\frac{1 + \sqrt{5}}{2}$$

and decimally equivalent to ˜1.618033988749 . . . ), then for each incoming edge i of the original node 103 (hereinafter denoted as j), the node 103 can scale their weights down by a factor of θ⁻², such that wᵢⱼ (n+1)=Φ⁻²wᵢⱼ(n+1). In addition, the node 103 can cause the incoming edges i of the new node 103 (hereinafter denoted as j¹), to be scaled down by a factor of ϕ⁻¹, such that wᵢⱼ_{¹} (n+1)=Φ⁻¹wᵢⱼ_{¹}(n+1). Second, the node 103 can scale the output edges for the new node 103. The output edges k for the new node 103 (node j¹), can be scaled up by a factor of ϕ, such that wᵢⱼ_{¹}ₖ (n+1)=Φwⱼ_{¹}ₖ(n).

Next, at block 5266 the node 103 can provide the input to both itself and the new node 103 as an input for processing. This allows for the neural network 100 to continue operating and processing the data from the data set 409, where previously the original node 103 was unable to fully process the input data. Once processed, the outputs of the original node 103 and the new, additional node 103 can be provided to the next layer in the neural network 100.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive an input for a first node of a neural network;
determine that the input is outside the input domain for the node of the neural network;
create a second node of the node of the neural network, the second node having the same edges and edge weights as the first node;
scale down each incoming edge of the first node;
scale down each incoming edge of the second node; and
scale up each outgoing edge of the second node.

2. The system of claim 1, wherein each incoming edge of the first node is scaled down by a factor of ϕ^{Δ2}, wherein ϕ represents the Golden Ratio.

3. The system of claim 1, wherein each incoming edge of the second node is scaled down by a factor of θ⁻¹, wherein ϕ represents the Golden Ratio.

4. The system of claim 1, wherein each outgoing edge of the second node is scaled up by a factor of ϕ, wherein ϕ represents the Golden Ratio.

5. A method, comprising:
receiving an input for a first node of a neural network;
determining that the input is outside the input domain for the node of the neural network;
creating a second node of the node of the neural network, the second node having the same edges and edge weights as the first node;
scaling down each incoming edge of the first node;
scaling down each incoming edge of the second node; and
scaling up each outgoing edge of the second node.

6. The method of claim 5, wherein each incoming edge of the first node is scaled down by a factor of ϕ⁻², wherein ϕ represents the Golden Ratio.

7. The method of claim 5, wherein each incoming edge of the second node is scaled down by a factor of θ⁻¹, wherein ϕ represents the Golden Ratio.

8. The method of claim 5, wherein each outgoing edge of the second node is scaled up by a factor of ϕ, wherein ϕ represents the Golden Ratio.

9. A non-transitory, computer-readable medium, comprising machine-readable instructions that, when executed by a processor of a computing device, cause the computing device to at least:
receive an input for a first node of a neural network;
determine that the input is outside the input domain for the node of the neural network;
create a second node of the node of the neural network, the second node having the same edges and edge weights as the first node;
scale down each incoming edge of the first node;
scale down each incoming edge of the second node; and
scale up each outgoing edge of the second node.

10. The non-transitory, computer-readable medium of claim 9, wherein each incoming edge of the first node is scaled down by a factor of ϕ⁻², wherein ϕ represents the Golden Ratio.

11. The non-transitory, computer-readable medium of claim 9, wherein each incoming edge of the second node is scaled down by a factor of θ⁻¹, wherein ϕ represents the Golden Ratio.

12. The non-transitory, computer-readable medium of claim 9, wherein each outgoing edge of the second node is scaled up by a factor of ϕ, wherein ϕ represents the Golden Ratio.
